(19) United States
(12) Patent Application Publication
(10) Pub. No.: US 2001/0051212 A1
(43) Pub. Date: Dec. 13, 2001

(54) METHOD FOR ADJUSTING TEMPERATURE COEFFICIENT OF RESISTANCE OF TEMPERATURE-MEASURING RESISTIVE ELEMENT

(76) Inventors: HIROJI TANI, NAGAOKAKYO-SHI (JP); TEPPEI KUBOTA, KYOTO-SHI (JP)

Correspondence Address: OSTROLENK FABER GERB & SOFFEN, 1180 AVENUE OF THE AMERICAS, NEW YORK, NY, 100368403

(21) Appl. No.: 08/601,258

(22) Filed: Feb. 14, 1996

(30) Foreign Application Priority Data
Feb. 15, 1995 (JP) 7-26709

(51) Int. Cl. B05D 3/02; B05D 5/12

(52) U.S. Cl. 427/123; 427/126.2; 427/229; 427/383.5

(57) ABSTRACT

There is disclosed a method for adjusting the temperature coefficient of resistance (TCR) of a temperature-measuring resistive element comprising an electrically insulating base and a platinum film formed on the base. The platinum film is formed by sintering an organic platinum compound. The temperature coefficient of resistance (TCR) is adjusted by controlling either the temperature at which the platinum film is heat-treated after the formation of the platinum film or the thickness of the platinum film.

### BACKGROUND OF THE INVENTION

1. Field of the Invention

The present invention relates to a temperature-measuring resistive element using a platinum film as a resistor and, more particularly, to a method for adjusting the temperature coefficient of resistance of such a temperature-measuring resistive element.

2. Description of the Prior Art

A temperature-measuring resistive element making use of the dependence of platinum resistance on temperature has been put into practical use. Such a temperature-measuring resistive element has a platinum film formed either on an electrically insulating substrate or on a bobbin-like base. One example of this temperature-measuring resistive element is shown in FIG. 1.

The temperature-measuring resistive element 1 shown in FIG. 1 has an insulating substrate 2 made of, for example, alumina. A platinum film 3 is formed on the insulating substrate 2 by sputtering, vacuum evaporation, or other method. After formation, the platinum film 3 is subjected to a heat treatment at a relatively low temperature of 400 to 1200° C. to obtain required electric characteristics stably.

Thereafter, grooves 4 extending through the platinum film 3 in the direction of thickness of the substrate 2 are formed in the film by laser processing, a dry etching method, or any other method. As a result, a resistance circuit 5 having a meandering shape and terminal electrodes 6 and 7 are formed. The terminal electrodes 6 and 7 form opposite ends of the resistance circuit 5. An overcoat glass (not shown) is formed on the resistance circuit 5. Lead wires or other conductive members are connected to the terminal electrodes 6 and 7, respectively.

In the temperature-measuring resistive element 1 fabricated as described above, the temperature coefficient of resistance (TCR) of the platinum film 3 has a relatively low value of less than 3800 ppm/° C. On the other hand, the DIN standards stipulate that the TCR of this film be 3850 ppm/° C., which is higher than the above value. More specifically, in Class A of the DIN standards, the stipulated TCR is 3850±5 ppm/° C. In Class B, the stipulated TCR is 3850±13 ppm/° C. Today, temperature-measuring resistive elements using platinum wires have temperature coefficients of resistance which satisfy the aforementioned DIN standards. However, excluding this type, almost all temperature-measuring resistive elements are unable to meet the DIN standards.

### SUMMARY OF THE INVENTION

It is an object of the invention to provide a method for adjusting the temperature coefficient of resistance (TCR) of a temperature-measuring resistive element using a platinum film in such a way that the temperature coefficient of resistance (TCR) is increased so as to satisfy the DIN standards, for example. It is another object of the invention to provide a method for producing a temperature-measuring resistive element having a temperature coefficient of resistance (TCR) which satisfies the DIN standards.

A method of adjusting a temperature coefficient of resistance of a temperature-measuring resistive element having an electrically insulating base and a platinum film formed on the base, the platinum film being formed by sintering an organic platinum compound, the method comprising the step of: controlling at least one of a thickness of the platinum film and a temperature at which the platinum film is heat-treated after formation of the platinum film, whereby adjusting the temperature coefficient of resistance of the platinum film.

A method for producing a temperature coefficient of resistance of a temperature-measuring resistive element, comprising the steps of: applying a organic platinum resinate paste to an insulating base; sintering the organic platinum resinate paste to form an platinum film on the insulating base; and heating the platinum film at a temperature of more than 1220° C.

### BRIEF DESCRIPTION OF THE DRAWINGS

For the purpose of illustrating the invention, there is shown in the drawing a form which is presently preferred, it being understood, however, that the invention is not limited to the precise arrangement and instrumentality shown.

FIG. 1 is a plan view showing a temperature-measuring resistive element according to the present invention.

FIG. 2 is a graph in which the temperature coefficient of resistance (TCR) of each platinum film is plotted against heat treatment temperature.

FIG. 3 is a graph in which the temperature coefficient of resistance (TCR) of each platinum film is plotted against a duration of heat treatment.

FIG. 4 is a graph in which the temperature coefficient of resistance (TCR) of each platinum film is plotted against film thickness.

### DETAILED DESCRIPTION OF THE INVENTION

The present invention is directed to a temperature-measuring resistive element comprising an electrically insulating base and a platinum film formed on the base. This platinum film is obtained by firing an organic platinum resinate paste. In accordance with the preferred embodiment of the present invention, at least one of the thickness of the platinum film and the temperature at which the film is subjected to a heat treatment after the formation of the film is controlled, thus adjusting the TCR of the platinum film.

We have found that the temperature coefficient of resistance (TCR) of the platinum film obtained by firing an organic platinum resinate paste depends on the film thickness and also on the heat treatment temperature after the formation of the film.

As mentioned above, in the present invention, at least one of the thickness of the platinum film and the heat treatment temperature after the formation of the film is controlled. Thus, a temperature-measuring resistive element having a temperature coefficient of resistance (TCR) satisfying, for example, the DIN standards or other desired TCR can be easily obtained.

Hereinafter, a method for producing a temperature-measuring resistive element and a method for adjusting the temperature coefficient of resistance (TCR) of the temperature-measuring resistive element will be explained with reference to the drawings.

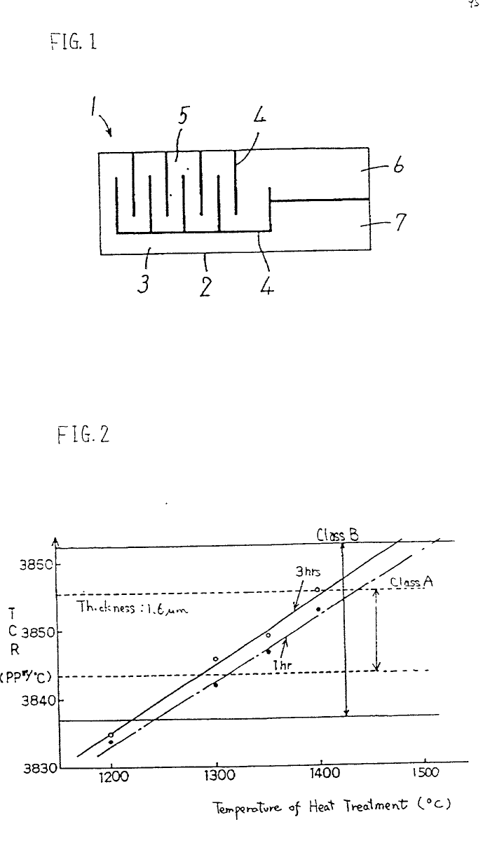

As shown in FIG. 1, an organic platinum resinate paste is applied to an insulating substrate 2. Any organic platinum compound can be used for the present invention as long as the organic platinum compound is stable in an air atmosphere at a normal temperature. However, it is preferable that a platinum purity of the organic platinum is 99.9% or greater. The insulating substrate 2 can be made of any kind of material which does not deform at a temperature about 1300° C. When the insulating substrate 2 is made of alumina having a purity of 96 to 99.9%, a temperature-measuring resistive element is provided with a good response due to a good thermal conductivity of alumina.

The applied organic platinum compound is preferably fired at a temperature of about 600 to 900° C., thus forming a platinum film 3 on the substrate 2. After forming the platinum film 3, a TCR of the platinum film 3 is preferably adjusted as described below.

Thereafter, grooves 4 are formed in the platinum film 3 to form a resistance circuit 5 having a meandering pattern (for example, the pattern shown in FIG. 1), as well as terminal electrodes 6 and 7, thereby producing the temperature-measuring resistive element 1.

The preferred method for adjusting the TCR of the platinum film 3 is described below.

FIG. 2 shows the relationship between the temperature coefficient of resistance (TCR) of the platinum film 3 and the temperature at which the film is subjected to a heat treatment after the formation of the platinum film 3 for a constraint platinum film thickness of 1.6 μm. As can be seen from this graph, by selecting a temperature of a heat treatment higher than about 1240° C., a temperature coefficient of resistance (TCR) satisfying the DIN standards is obtained. More specifically, a temperature-measuring resistive element satisfying Class A (3850±5 ppm/° C.) is obtained in the case where the temperature-measuring resistive element is heated at a temperature in the range of about 1310 to about 1440° C. for one hour or at a temperature in the range of about 1280 to 1400° C. for three hours. A temperature-measuring resistive element satisfying DIN Class B (3850±13 ppm/° C.) is also obtained in the case where the temperature-measuring resistive element is heated at a temperature in the range of about 1240 to about 1500° C. for one hour or at a temperature in the range of about 1220 to about 1470° C. for three hours.

In this way, the sinterability of the platinum film 3 is increased by elevating the heat treatment temperature of the platinum film 3. This makes it more dense, thereby increasing the temperature coefficient of resistance (TCR).

As is apparent from FIG. 2 in the case where the heat treatment time is 3 hours, a higher temperature coefficient of resistance (TCR) is obtained than where the time is 1 hour. Thus, it is understood that the temperature coefficient of resistance (TCR) can be controlled by controlling the heat treatment time and/or the heat treatment temperature. FIG. 3 shows the relation of the temperature coefficient of resistance (TCR) of the platinum film 3 to the duration of the heat treatment.

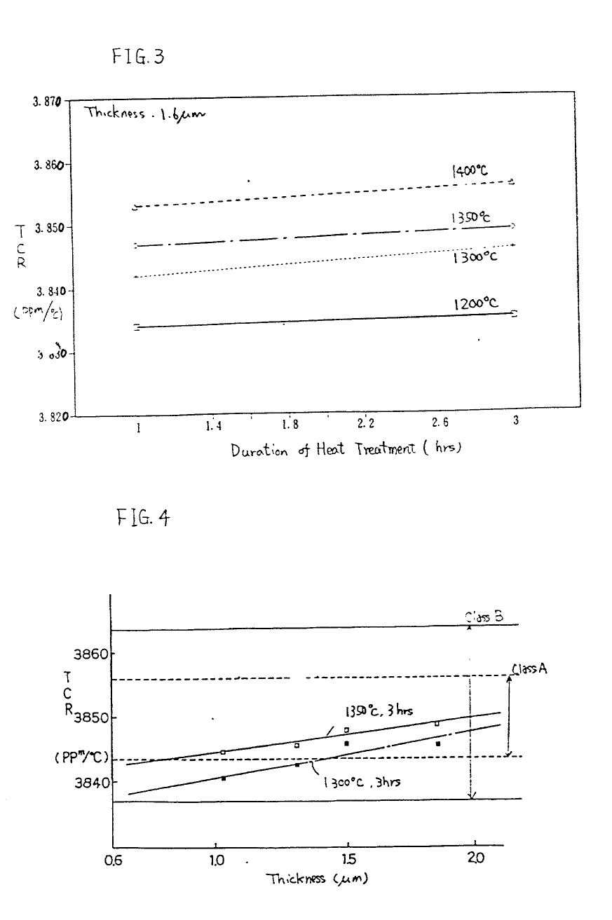

FIG. 4 shows the relation of the temperature coefficient of resistance (TCR) of the platinum film 3 to its thickness. The graph shows cases in which the platinum film thickness 3 is heat-treated at 1350° C. for 3 hours and at 1300° C. for 3 hours, respectively. It can be seen from this graph that as the thickness of the platinum film 3 is increased, the temperature coefficient of resistance (TCR) is increased.

As can be understood from the above example, the temperature coefficient of resistance (TCR) of the platinum film can be adjusted by controlling any one or both of the thickness of the platinum film and the heat treatment temperature (or heat treatment time) after the formation of the film. As a result, a temperature-measuring resistive element having a desired temperature coefficient of resistance (TCR) can be easily obtained.

Although the present invention is explained as a method for adjusting a temperature coefficient of resistance of a temperature-measuring resistive element having a platinum film, the present invention is also applied to a method for adjusting a temperature coefficient of resistance of a temperature-measuring resistive element having another noble metal film. For example, a temperature coefficient of resistance of a temperature-measuring resistive element having a noble metal film which is made of Ruthenium (Ru), Palladium (Pd), Iridium (Ir), or Rhodium (Rh) is also adjusted by the method of the present invention.

The present invention may be embodied in other specific forms without departing from the spirit or essential attributes thereof and, accordingly, reference should be made to the appended claims, rather than to the foregoing specification, as indicating the scope of the invention.

What is claimed is:

1. A method of adjusting a temperature coefficient of resistance of a temperature-measuring resistive element having an electrically insulating base and a platinum film formed on the base, the method comprising the steps of:
forming a platinum film by sintering an organic platinum compound located on the base; and
controlling at least one of a thickness of the platinum film and a temperature at which the platinum film is heat-treated after formation of the platinum film so as to adjust the temperature coefficient of resistance of the platinum film.

2. A method of adjusting a temperature coefficient of resistance of a temperature-measuring resistive element having an electrically insulating base and a platinum film formed on the base, the method comprising the steps of:
forming the platinum film by sintering an organic platinum compound located on the base; and
intentionally controlling a time during which the platinum film is heat-treated after formation of the platinum film for the purpose of adjusting the temperature coefficient of resistance of the platinum film.

3. A method for producing a temperature coefficient of resistance of a temperature-measuring resistive element, comprising the steps of:
applying a organic platinum compound to an insulating base;
sintering the organic platinum compound to form an platinum film on the insulating base; and
heating the platinum film at a temperature of more than 1220° C.

4. The method according to claim 3, further including the step of determining the temperature to which the platinum film should be heated to ensure that the temperature-measuring resistive element will have a predetermined temperature coefficient of resistance of the platinum film and wherein said heating step heats the platinum film to the determined temperature.

5. The method according to claim 4, wherein the platinum film is heated to a temperature which results in the temperature coefficient of resistance of the platinum film being at 3850±5 ppm/° C.

6. The method according to claim 4, wherein the platinum film is heated to a temperature which results in the temperature coefficient of resistance of the platinum film is 3850±13 ppm/° C.
